(19) United States
(12) Patent Application Publication
(10) Pub. No.: US 2015/0089372 A1
(43) Pub. Date: Mar. 26, 2015

(54) METHOD OF USER INTERACTION FOR SHOWING AND INTERACTING WITH FRIEND STATSU ON TIMELINE

(71) Applicant: General Instrument Corporation, (US)

(72) Inventors: Hiren M. Mandalia, Schaumburg, IL (US); Santosh S. Basapur, Hanover Park, IL (US); Shirley A. Chaysinh, Grayslake, IL (US); Young S. Lee, Palatine, IL (US); Narayanan Venkitaraman, Palatine, IL (US)

(73) Assignee: GENERAL INSTRUMENT CORPORATION, Horsham, PA (US)

(21) Appl. No.: 13/622,108

(22) Filed: Sep. 18, 2012

(51) Int. Cl. H04L 29/06; G06F 3/0482; G06F 3/0484; G06F 3/0481

(52) U.S. Cl. CPC H04L 65/403; G06F 3/04817; G06F 3/0482; G06F 3/04842
USPC 715/720

(57) ABSTRACT

A system and method of viewing media content on a timeline is presented. In accordance with an embodiment of the invention, a companion device user interface provides the user a second screen experience on a companion device by giving the user an opportunity to create secondary supplemental content related to the media content they are watching on a primary screen, such as a television. The user interface provides the user interaction by using visual indicators on a timeline to show the current position of all their friends, who are watching the same media content, along with the status of their media players. Being able to view the current status of all the friends on a timeline enables the users to make relevant comments to each other as the show progresses.

### BACKGROUND

Embodiments of present invention relate to synchronized media, in particular, synchronized media for user interaction through a visual interface.

What is needed is a system and method of user interaction with the status of friend on a timeline.

### BRIEF SUMMARY OF THE DRAWINGS

The accompanying drawings, which are incorporated in and form a part of the specification, illustrate example embodiments of the present invention and, together with the description, serve to explain the principles of the invention. In the drawings:

FIG. 1 illustrates a media system 100 for synchronizing media content;

FIGS. 2A-2B illustrate synchronization of media content indicated by progress bars;

FIGS. 3A-3E illustrate few example embodiments of media synchronization with reference to a timeline;

FIGS. 4A-4C illustrate an example embodiment of media synchronization with reference to a timeline;

FIG. 5 illustrates an example embodiment of a media system for media synchronization among the users using a companion device;

FIG. 6 illustrates an example embodiment of a video receiver;

FIG. 7 illustrates a process for a media synchronization system, in accordance with an embodiment of the invention;

FIGS. 8A-8B illustrate a flow diagram for a media synchronization system, in accordance with an embodiment of the invention; and

FIG. 9 illustrates an example screen shot for a user interface, in accordance with an embodiment of the invention.

### DETAILED DESCRIPTION

In recent years, television viewing experience is augmented to include social network element through interactive games, applications, live chat, and social networking feeds presented on a companion screen, such as, a smart phone, tablet, or internet connected computer.

Methods for synchronizing media content, where presentation of the media content during trick plays (fast-forward, rewind, play, pause, etc.) is synchronized among the multiple media players, are known in the art. Non-limiting examples of media content include audio, video, audio and video, electronic books, slide show etc.

U.S. Pat. No. 8,006,274 to Samuel Thomas Scott, III, is an example of a known method of synchronizing media content. In the '274 patent, a media server identifies multiple media, entertainment systems, wherein each is capable of presenting a particular media content. Synchronization commands are communicated to each of the media entertainment systems, causing each system to pause, play, fast-forward, rewind, or jump to a particular point within the particular media content, thereby synchronizing presentation of the media content among the multiple media entertainment systems. In this reference, a user of one of the media entertainment systems may enter a control command (e.g., rewind, pause, play, fast-forward, channel change, etc.) to the media server. The media server then communicates the control command to each of the media entertainment systems, thereby enabling synchronized, user control of the particular media content. Synchronization commands and/or control commands may be communicated over any type of network, such as an IP network, a voice-over-IP (VOIP) network, or a media network (e.g., a cable network). Control commands may be submitted by a user via a user interface provided by the media entertainment system or as a voice or touch-tone command, for example, over a VOIP network.

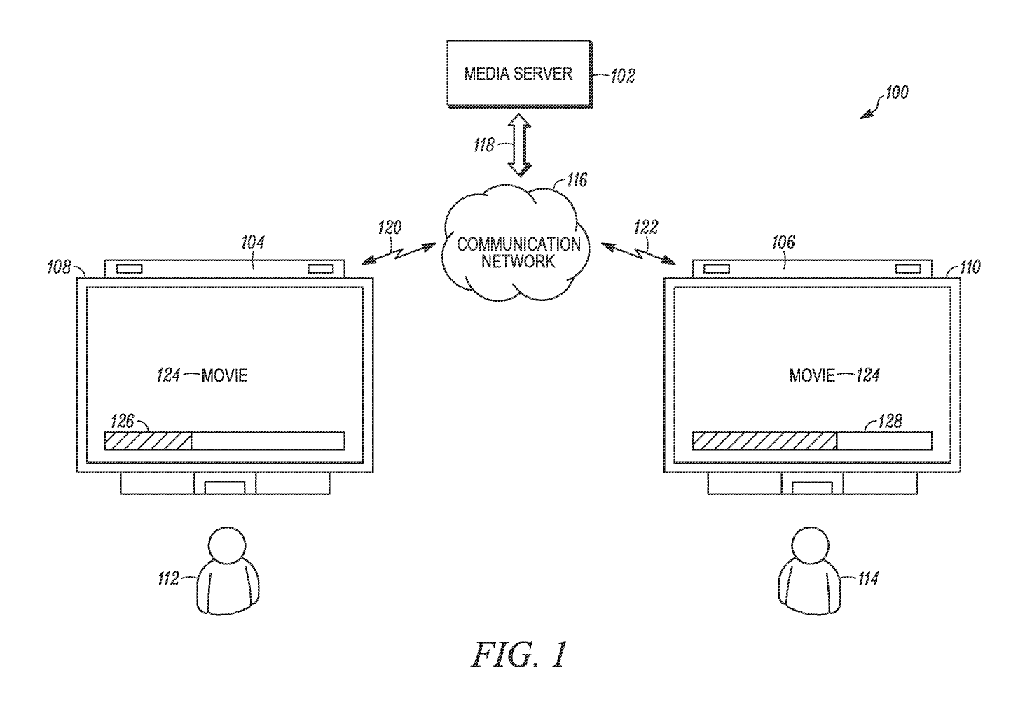

Embodiments of the present invention provide additional features over known methods of synchronizing media content. In accordance with embodiments of the present invention, media content synchronization may be represented by progress bars, which indicate a timeline associated with the media content. In non-limiting example embodiments, a timeline displayed on a media player playing content of one user may provide an indication of the status of that user in addition to the status of media players playing the same content for other users. Further, in non-limiting example embodiments, a user interface may enable a user of one media player playing content to synchronize with the media player playing the same content of another user. A media system for synchronizing two or more client devices in accordance with non-limiting example embodiments is explained with the help of FIG. 1.

FIG. 1 illustrates a media system 100 for synchronizing media content in accordance with non-limiting example embodiments.

As illustrated in the figure, a media server 102 is operable to exchange media content information with a client device 104 and a client device 106 via a communication network 116 using a communication channel 118. An icon 112 representing a user who is watching a movie 124 using his client device 104 on a primary screen 108 and an icon 114 that is representing a user who is watching same movie 124 using his client device 106 on a primary screen 110.

Client device 104 is operable to communicate with media server 102 via a communication channel 120 through communication network 116. Client device 106 is operable to communicate with media server 102 via a communication channel 122 through communication network 116. Communication network 116 may be a media network, an Internet Protocol (IP) based network, etc. Client device 104 and client device 106 may be any media player, i.e., device that is able to play media, non-limiting examples of which include a satellite receiver, a Set-Top-Box (STB), a Digital Video Recorder (DVR), a game console, a personal computer, a tablet, a smartphone and so forth.

An icon may be any image, whether static or changing, that may be used to represent aspects of the user corresponding to that icon. An icon corresponding to one user may be different from an icon corresponding to a different user in some manner, non-limiting examples of which include color, shape, size, sound, haptics and animation. An icon may include a status indicator indicating what the media player corresponding to the user of that icon is currently performing. In some non-limiting embodiments, the status indicator may include a symbol indicating that the media player corresponding to the user of that icon performing at least one of: playing the media content; pausing the media content (performing a pausing action); fast-forwarding the media content (performing a pausing action); rewinding the media content (performing a rewinding action); being away from the media player; typing a message; being offline; being busy; and being synchronized with another person/group.

A progress bar 126 on primary screen 108 and a progress bar 128 on primary screen 110 represent media content synchronization as the user corresponding to icon 112 and the user corresponding to icon 114 are watching movie 124. Any trick plays (e.g., fast forward, rewind, etc.) performed by a user are reflected by the respective progress bar on their primary screen.

In accordance with embodiments, an icon for each media player playing the content may be displayed on each media player in conjunction with a progress bar associated with the content. Information relating to the point within the content and the status of each media player, e.g., currently playing, pausing, fast forwarding, etc., is shared with the other media players that are in communication. This shared information may be used by all the media players to provide a graphical representation of each media player, for example by placing an icon for each respective media player on a common progress bar associated with the content. The media players may then be synchronized. Any known method of synchronizing media players may be used, in order to synchronize at least two media players. In a non-limiting example embodiment, to initiate a synchronized media interaction, users corresponding to icons 112 and 114 and any additional users may request to form a new synchronization group, i.e., a group that is to be synchronized, or to join an existing synchronization group, i.e., a group that is currently synchronized. Media server 102 is operable to communicate with client device 104 and 106 for synchronized media interaction such that users corresponding to icons 112 and 114 are able to watch movie 124 synchronized within a timeline as indicated by progress bar 126 and 128.

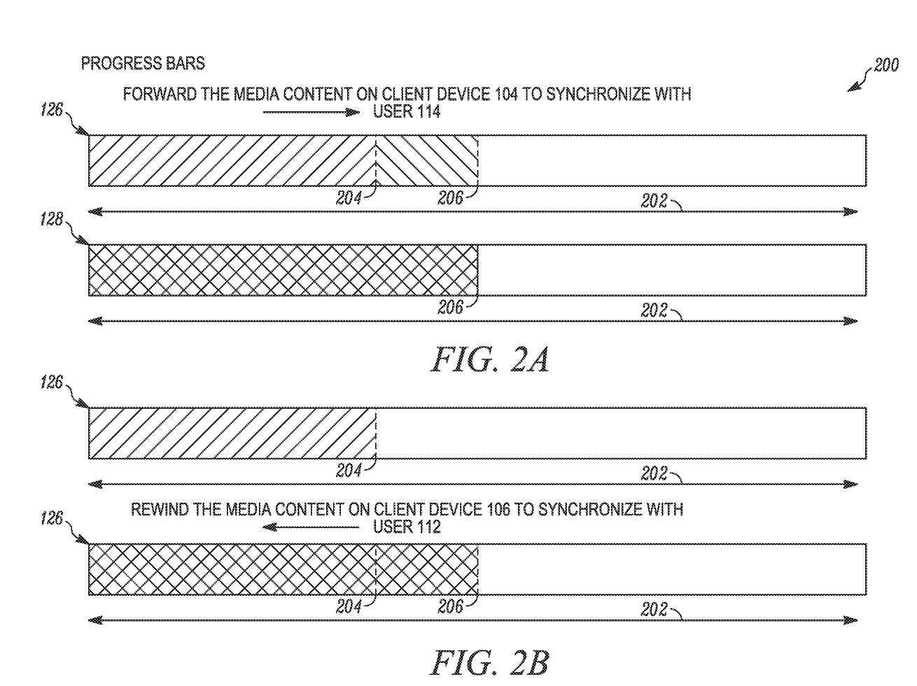

In a media system in accordance with non-limiting example embodiments, initial synchronization between users may be established by converging the group members to a common point in the timeline through any combination of fast forward and/or rewind. Once the initial synchronization is established, client device 104 and 106 communicate to media server 102 any commands received by users corresponding to icons 112 and 114 relating to viewing the media content. Media server 102 maintains synchronization among the group members by forwarding a command received from one client device to all the client devices such that the client devices execute those commands substantially at the same time. In the case of multiple commands received from different client devices, media server 102 can prioritize the execution of the commands in an order determined based on a pre-determined criterion. Few examples of synchronization indicated by progress bars are discussed with the help of FIGS. 2A-2B.

FIGS. 2A-2B illustrate synchronization of media content indicated by progress bars in accordance with non-limiting example embodiments.

As illustrated in FIG. 2A, a timeline 202 indicates total length of movie 124. As an example, assuming that the user corresponding to icon 112 has watched movie 124 until a time 204 as indicated on progress bar 126 and the user corresponding to icon 114 has watched movie 124 until a time 206 as indicated on progress bar 128. If the user corresponding to icon 112 wants to synchronize with the user corresponding to icon 114 for media interaction so that they are both watching movie 124 at the same position within timeline 202, based on a command entered by user 112, media content viewed by the users can be synchronized by media server 102 by instructing client device 104 to fast forward the media content such that icon 112 is at the same position 206 as icon 114 on timeline 202.

Alternatively, as illustrated in FIG. 2B, based on a different command entered by the user corresponding to icon 114, media server 102 can instruct client device 106 to rewind the media content such that icon 114 is at the same position 204 as icon 112 on timeline 202.

As discussed with the help of FIGS. 1, 2A-2B, synchronization among the users in a group is maintained by presenting the media content to the users at substantially identical positions in a timeline associated with the media content. Non-limiting example embodiments provide a mechanism where the status of all the users within the group is visible on a timeline.

Different users, as part of a group, may start, watching the same show at different times, which creates a situation when they want to know if their friends are ahead or behind in watching the same show before posting any comments or secondary media related to the show. In some cases, they may not have any motivation in posting a comment about certain event in the show knowing that their friends have already passed that point in the show. In most of the cases, users would like to synchronize with their friends within a group, so that they are at the same point within the show and therefore are making relevant comments to each other as the show progresses.

Non-limiting example embodiments provide a system and method of user interaction for showing and interacting with the status of a friend on a timeline. Companion devices offer the users a personalized and interactive second screen experience for sharing their thoughts with their friends and family in real time, while watching the same television program.

The user interface provides the user interaction by using visual indicators on a timeline to show the current position of all their friends, who are watching the same media content, along with the status of their media player. Non-limiting examples of a status of a media player include pause, play, forward, rewind, typing a post, exploring related media, searching content to post, and currently synchronized. Non-limiting examples of visual indicators include static icons, dynamic icons—e.g., icons that change in shape, size, color, brightness, combinations thereof, etc.—, profile photographs, avatars, etc. A timeline for each user can be displayed on the primary screen (for example, a television) of each user or his companion device, which is in communication with the primary screen. Some non-limiting examples of companion devices are smart phone, tablet, internet enabled computer, laptop, wearable computer, or gaming device, etc.

In one embodiment, a user can send a soft invite to a group of friends on a buddy list for watching a show. As the friends start watching the show, corresponding icons start showing up on a timeline on each user's primary screen or their companion device. Depending on which point in time each user started watching the show, at any instant, the timeline for each user may or may not have the media content progressed to an identical point. For example, one user may be half done with watching the show while another user is just starting to watch the show. In some cases, some users may be watching the same show at a totally different time or day.

Embodiments of the invention provide loose or tight coupling between the users for media synchronization. In some non-limiting examples embodiments of the invention, a user can take actions on his/her friend's status icon (for example, by clicking or dragging his/her icon on to their friend's icon) to synchronize with a friend or a group of friends for loose coupling between the friends. In this case, timelines for both the friends will synchronize to the same point of the associated media content. In some non-limiting example embodiments of the invention, a user may already be in a synchronized group, wherein the user can take actions on another friend's status icon (for example, by clicking or dragging an icon within his currently synchronized group on to the other friend's icon) to synchronize with the new friend for loose coupling between the currently synchronized group and the new friend. In some non-limiting example embodiments of the invention, a user may already be in a synchronized group, wherein the user can take actions on another currently synchronized groups status icon (for example, by clicking or dragging an icon within his currently synchronized group on to an icon within the other synchronized group) to synchronize with the new group for loose coupling. In any of these cases, timelines for both the friends will synchronize to the same point of the associated media content. Controls of the respective media players may still be kept independent.

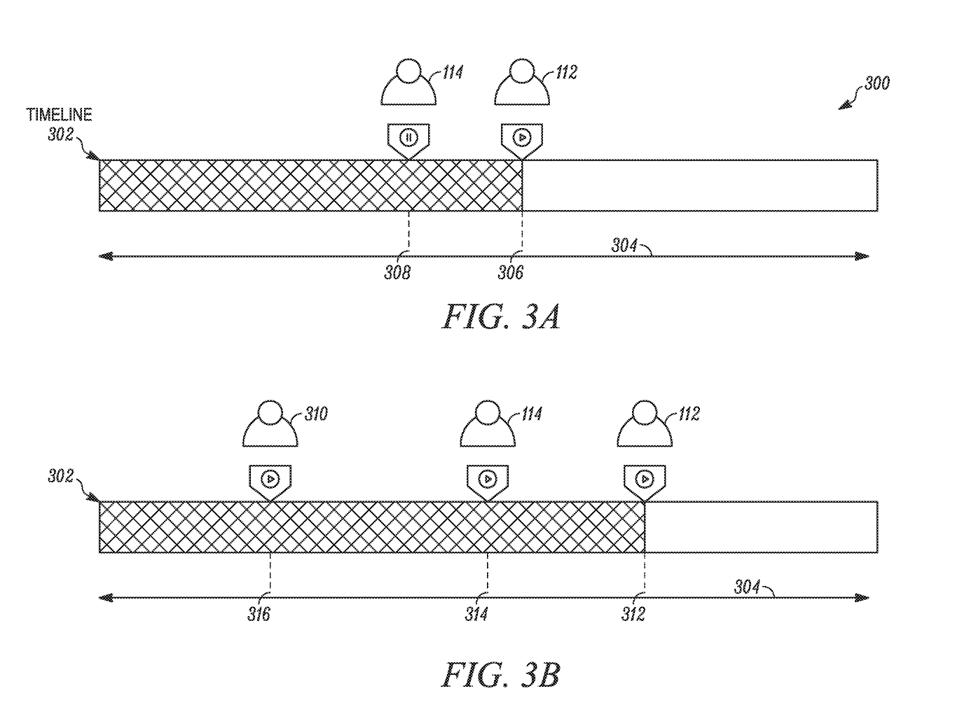

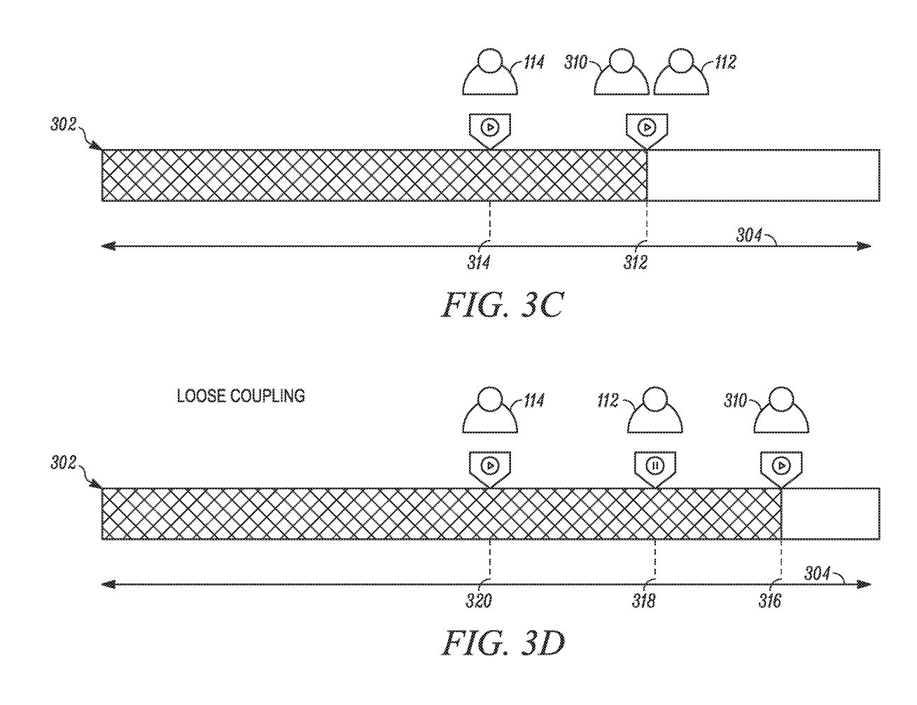

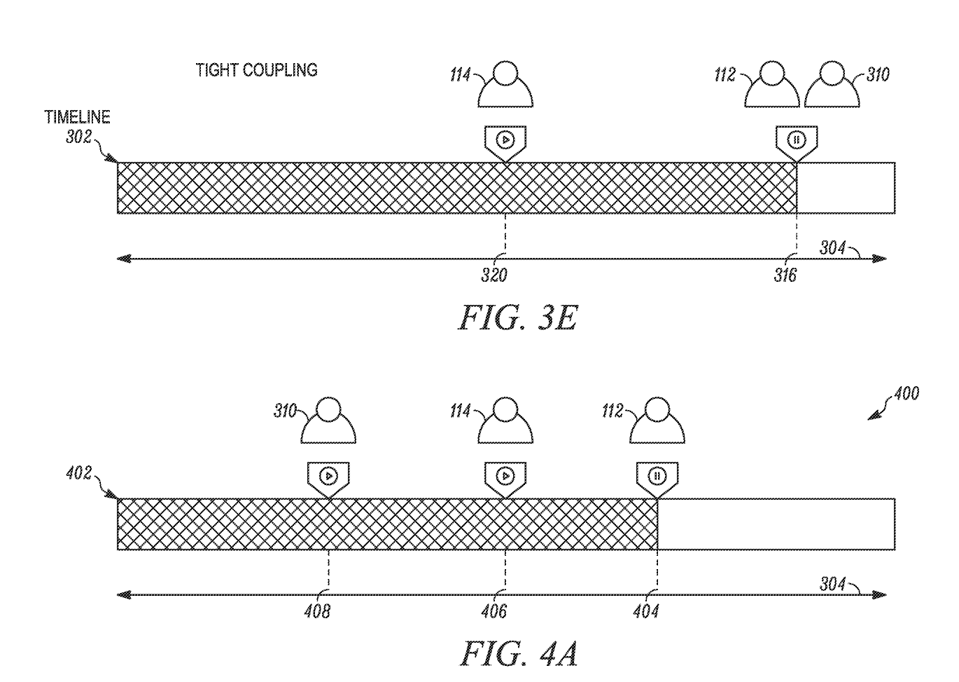

In another embodiment of the invention, a user can pair up with a friend or a group of friends for tight coupling between the friends. In this case, the media players are more explicitly synchronized and all the actions executed by the media players of the paired-up users are duplicated in addition to synchronizing the timelines. Different embodiments of the invention, as discussed above, with reference to a timeline, are further explained with the help of FIGS. 3A-3E.

FIGS. 3A-3E illustrate a few non-limiting example embodiments of media synchronization with reference to a timeline.

As illustrated in FIG. 3A, status of the user corresponding to icon 112 and the user corresponding to icon 114 is displayed on a timeline 302, where the total length of the media content is 304. Icon 112 displays the status “play” for the user corresponding to icon 112, who has progressed up to a position 306 on timeline 302. The user corresponding to icon 114, on the other hand, is behind in viewing the media content relative to the user corresponding to icon 112, and is currently “paused” at a position 308, as shown by icon 114 on timeline 302. As more friends start watching the show, their corresponding icons start showing up on timeline 302.

As illustrated in FIG. 3B, a new user 310 has joined the group, who is playing the media content at a position 316. As this instant of time, icon 112 is showing the status “play” for user corresponding to icon 112 at a position 312 and icon 114 is showing the status “play” for the user corresponding to icon 114 at a position 314.

FIG. 3C illustrates an embodiment of the invention, when a user wants to synchronize with a friend or a group of friends by dragging his/her icon on to their friend's icon. As illustrated in the figure, user 310 is synchronized with the user corresponding to icon 112 as shown at position 312 on timeline 302. Now both users corresponding to icons 112 and 310 are at an identical position within the show. The synchronization between the users corresponding to icons 112 and 310 can either be loosely coupled as illustrated with the help of FIG. 3D or tightly coupled as illustrated with the help of FIG. 3E.

In loosely coupled case, timelines for both the users will be synchronized on their primary or companion screen and brought to the same point of the associated media content. Controls of the respective media players are still kept independent, as illustrated with the help of FIG. 3D. Once the users corresponding to icons 112 and 310 were synchronized at position 312, as shown in FIG. 3C, the user corresponding to icon 112 decides to pause little bit later at a position 318, while the user corresponding to icon 310 is continuing to play at a position 316. Note that the status of the user corresponding to icon 114 is also visible, who is playing at a position 320.

In tightly coupled case, the media players are more explicitly synchronized and all the actions executed by the media players are duplicated in addition to synchronizing the timelines as illustrated with the help of FIG. 3E. For example, after synchronizing at position 312, as shown in FIG. 3C, if the user corresponding to icon 112 decides to pause the media presentation, the media player for the user corresponding to icon 310, will pause as well, as indicated by position 316. The duplication of actions/events requested by one user on the media player of the other users could be partial or complete as desired by the users.

In other example embodiments of loose or tight coupling, the experience of seeing the secondary content could also be synchronized. For example, when users are tightly coupled, in addition to the synchronous media playback, they may additionally enjoy the exact same secondary content on their respective companion devices. In one instance, when a set of users form a tightly coupled group, then the media server informs the tight coupling status to the secondary or supplemental content service (SCS) that is generating the supplemental content related to the primary media for different users. The SCS, in turn, generates the same related content for the group, based on the factors such as the common interest in the profile of user's in the group, their recent comments media status, etc. SCS also receives the coupled group status update when one or more users leave the group or the group is disbanded.

As discussed above with reference to FIGS. 3A-3E, in one embodiment of the invention, the media player of the user, who initiated the synchronization by dragging his/her icon on to their friend's icon, performs actions on the associated media content (for example, fast forward or rewind) to bring it to the same point as their friend so that they are at an identical position within the show. Each media player may have a copy of the same media content in order to execute different trick-play commands on respective media players.

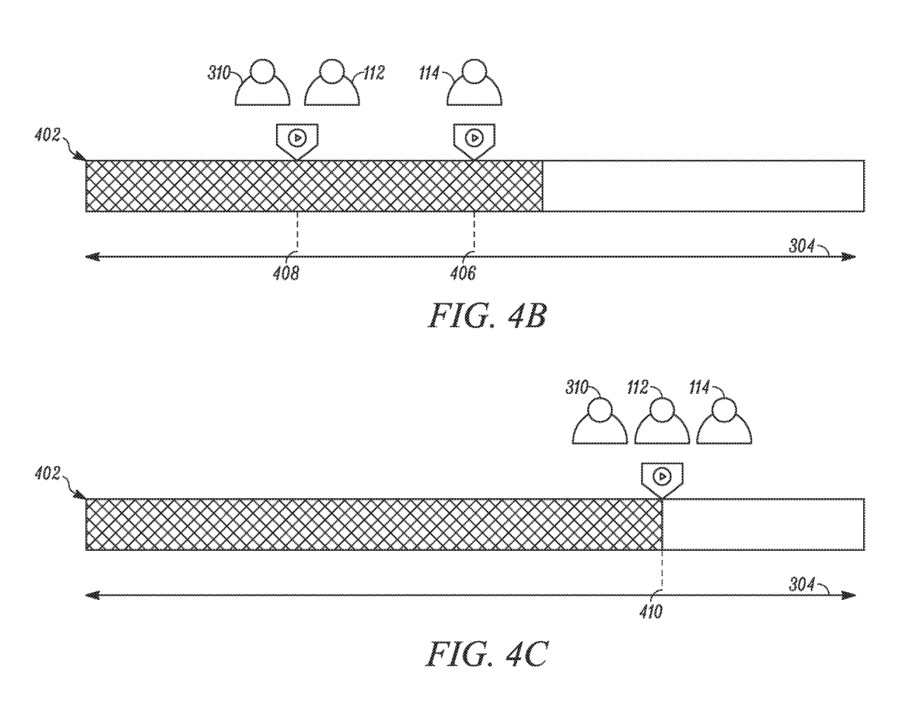

In another embodiment of the invention, the user can send a request to their friends for synchronizing with him/her to be at the same point in the show. In an example embodiment, the request may manifest as a question provided by the friend's media player's user interface, wherein the friend may be asked to synchronize. If accepted, the friend's media player may send information related to his actions to the requesting media player to enable synchronization. In this case, the media players for the friends can execute fast forward or rewind on their respective media players to be at the same point in the show as the user who initiated the synchronization request. This is further explained with the help of FIGS. 4A-4C.

FIGS. 4A-4C illustrate an example embodiment of media synchronization reference to a timeline.

As illustrated in FIG. 4A, status of the user corresponding to icon 112, the user corresponding to icon 114 and the user corresponding to icon 310 is displayed on a timeline 402, where the total length of the media content is 304. Note that timeline 402 can be displayed on the primary screen or the companion device of the users, in accordance with embodiments of the invention. In this example, the user corresponding to icon 112 is at a position 404, the user corresponding to icon 114 is at a position 406 and the user corresponding to icon 310 is at a position 408 within media content 304.

If the user corresponding to icon 310 wants the user corresponding to icon 112 to synchronize with him for some reason, he can request the user corresponding to icon 112 to synchronize via his companion device. As illustrated in FIG. 4B, once the user corresponding to icon 112 receives a request for synchronization from the user corresponding to icon 310, he can drag his icon back on to icon 310. This results in the media player of the user corresponding to icon 112 rewinding the associated media content to position 408 so that both the users corresponding to icons 310 and 112 are at an identical position within timeline 402.

Further on, as illustrated in FIG. 4C, synchronization between the users corresponding to icons 112 and 310 is tightly coupled and they have progressed to a position 410 together. If the user corresponding to icon 114 wants to synchronize with the user corresponding to icon 310 and 112, he can drag his icon to icons 310 and 112 to synchronize with them. Now the media player for the user corresponding to icon 114 can fast-forward the associated media content to position 410 so that the users corresponding to icons 310, 112 and 114 are at an identical position within timeline 402.

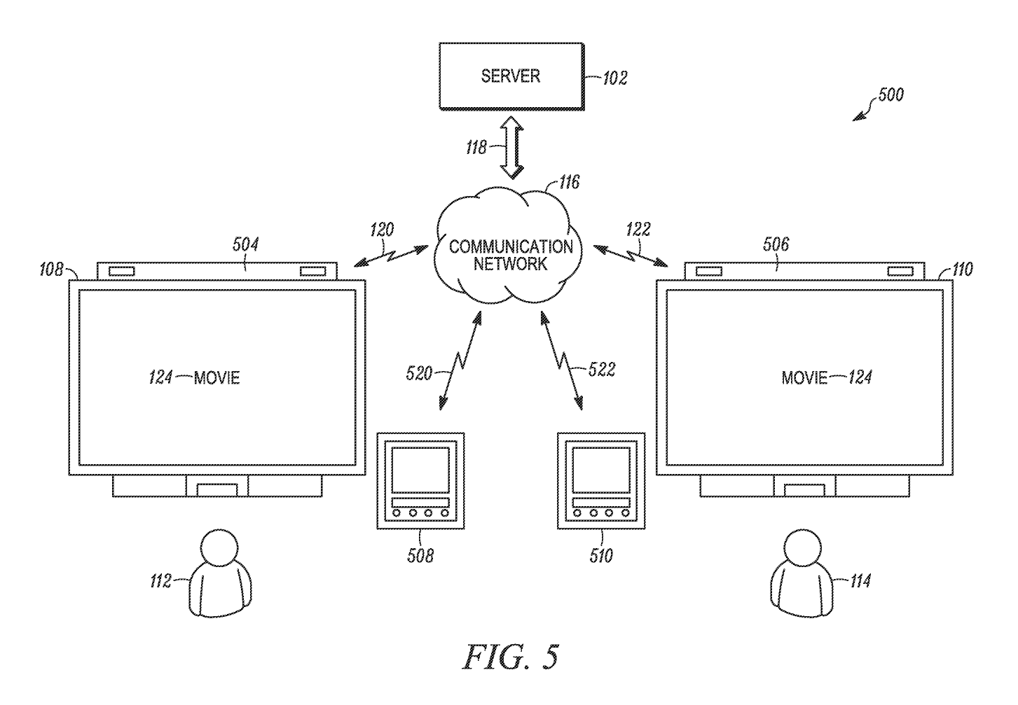

As illustrated with reference to FIGS. 3A-3E, and 4A-4C, different embodiments of the invention provide the users visual interaction for media synchronization with other users. In the embodiments discussed with reference to FIGS. 3A-3E and 4A-4C, all the icons are associated with a single timeline. However, in some embodiments, an icon may be associated with its own timeline, wherein another icon (or other icons) may be associated with another timeline. A media system for providing media synchronization among the users using companion device is discussed below with the help of FIG. 5.

FIG. 5 illustrates an example embodiment of a media system for media synchronization among the users using a companion device.

As illustrated in the figure, a media system 500 includes server 102, a video receiver 504, a video receiver 506, communication network 116, a companion device 508 and a companion device 510, in addition to some components from media system 100, namely, primary screens 108 and 110 and the users corresponding to icons 112 and 114. Video receiver 504 and video receiver 506 are similar to client devices 104 and 106 respectively, except that they are also operable to communicate with companion devices 508 and 510.

Server 102 is operable to communicate with video receiver 504, video receiver 506, companion device 508, and companion device 510 through communication network 116 via communication channel 118. Video receiver 504 is operable to communicate via communication channel 120 through communication network 116. Video receiver 506 is operable to communicate via communication channel 122 through communication network 116. Some non-limiting examples of video receiver 504 and video receiver 506 may be any media player, i.e., device that is able to play media, non-limiting examples of which include a satellite receiver, a Set-Top-Box (STB), a Digital Video Recorder (DVR), a game console, a personal computer, a tablet, a smartphone and so forth.

Companion device 508 and companion device 510 provide the users corresponding to icons 112 and 114 a second screen experience by giving them an opportunity to create secondary supplemental content related to media content 124 they are watching on primary screen 108 and 110. Some non-limiting examples of companion device 508 and 510 are smart phones, tablets, personal digital assistants (PDAs), internet enabled computers, or laptops, etc. Companion device 508 is operable to communicate via a communication channel 520 through communication network 116. Similarly, companion device 510 is operable to communicate via a communication channel 522 through communication network 116.

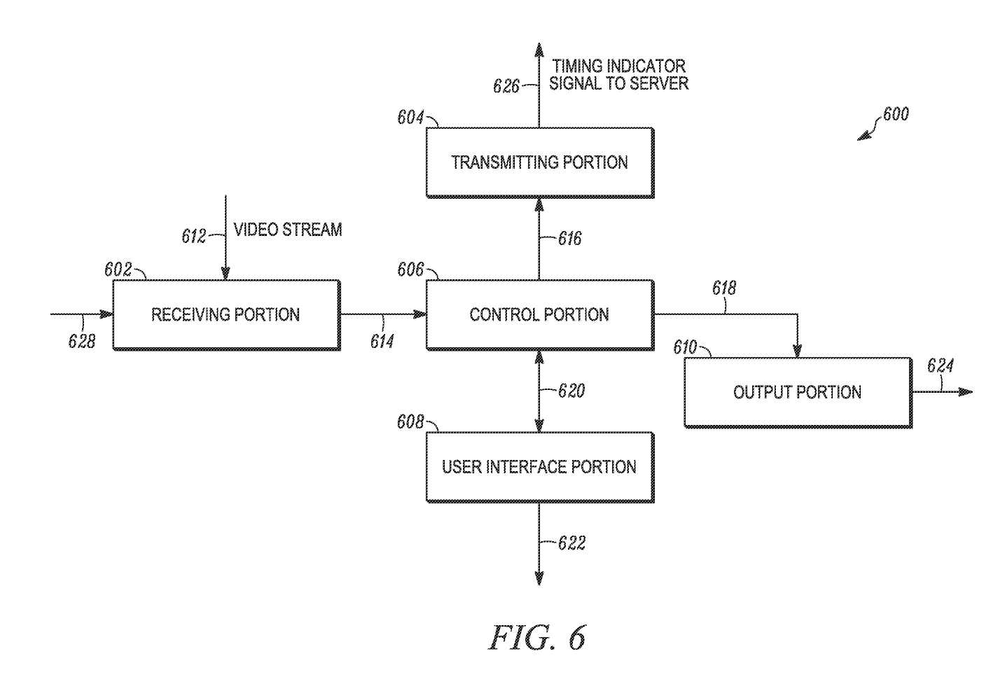

In one embodiment, the user corresponding to icon 112 can invite the user corresponding to icon 114 for watching movie 124 through his companion device 508. As the users corresponding to icons 112 and 114 start watching the show, corresponding icons start showing up on a timeline on primary screen 108 and 110 or companion device 508 and 510. Depending on whether both the users corresponding to icons 112 and 114 started watching movie 124 at the same time or at different times, and as the show progresses on the various scenarios for the visual interaction between user 112 and 114 are possible, as discussed with reference to FIGS. 3A-3E and 4A-4C. In order to maintain media synchronization and user interaction, video receiver 504 and video receiver 506 are operable to execute different trick-play commands (fast forward, rewind, pause, etc.) as desired, which may be initiated by the users corresponding to icons 112 and/or 114 or server 102. Different components of media system 500 are discussed in detail with the help of FIG. 6.

FIG. 6 illustrates an example embodiment of a video receiver.

As illustrated in the figure, a video receiver 600 includes a receiving portion 602, a transmitting portion 604, a control portion 606, a user interface portion 608, and an output portion 610. In this example, receiving portion 602, transmitting portion 604, control portion 606, user interface portion 608, and output portion 610 are distinct elements. However, in some embodiments, at least two of receiving portion 602, transmitting portion 604, control portion 606, user interface portion 608, and output portion 610 may be combined as a unitary element. In other embodiments, at least one of receiving portion 602, transmitting portion 604, control portion 606, user interface portion 608, or output portion 610 may be implemented as a computer having stored therein tangible computer-readable media for carrying or having computer-executable instructions or data structures stored thereon.

Receiving portion 602 is operable to receive a video stream data 612 and to provide it to control portion 606 via a signal 614 along with some control signals. Video stream data 612 may be received from a satellite, a media network, a communication network, internee, and so forth. In one embodiment, video stream data 612 is received from server 102. Receiving portion 602 is further operable to receive a control signal 628 from server 102. In one embodiment, control signal 628 includes a synchronization signal based on a timing indicator or a trick-play indicator received by server 102 from a video receiver.

Control portion 606 is operable to receive the video stream data from receiving portion 602 and to process it before forwarding it to output portion 610. Control portion 606 is further operable to generate a timing indicator signal related to the video stream data for media server 402. In one embodiment, timing indicator signal is based on the status of the user's media player, non-limiting examples of a status of a user's media player include pause, play, fast-forward, rewind, typing a post, exploring related media, searching content to post, and currently synchronized, relative to a timeline for the video stream data. Control portion 606 is further operable to modify the video stream data before forwarding it to output portion 610 based on the synchronization signal received from receiving portion 602.

Output portion 610 is operable to receive video data via a signal 618 from control portion 606 and to provide it as an output video data for viewing via a signal 624. For example, output portion 610 may provide video data signal 624 to primary screen 108 or 110 for viewing.

User interface portion 608 bi-directionally communicates with control portion 606 via a signal 620. User interface portion 608 is operable to generate a user interface via a signal 622 that includes a timing indication related to video stream 612. In one embodiment, timing indication is displayed on a companion device as a timeline with status icons for different users. As an example, user interface portion 608 generates a timeline 302 that indicates status of different users using visual icons within the duration of media content 304. In one embodiment, the user corresponding to icon 112 communicates with companion device 508 to create secondary supplemental content, such as a comment or a post, related to video stream 612. User interface portion 608 is further operable to generate a second timing indication based on the synchronization signal received via signal 620 for updating the timing indicator based on synchronization between the users.

Transmitting portion 604 is operable to receive the timing indicator signal generated by control portion 606 via a signal 626 and to provide it to server 102 via a signal 626.

Referring back to FIG. 5, assuming user 112 sends a request through video receiver 504 to server 102 for user 310 to synchronize with him at position 312, server 102 forwards a synchronization signal to the video receiver for user 310 (not shown). Synchronization signal is received by receiving portion 602 and forwarded to control portion 606, which modifies the video stream data for the media content to be forwarded to position 312 from position 316. Synchronization of user 112 and 310 is indicated on timeline 302 based on the second timing indication generated by user interface portion 608.

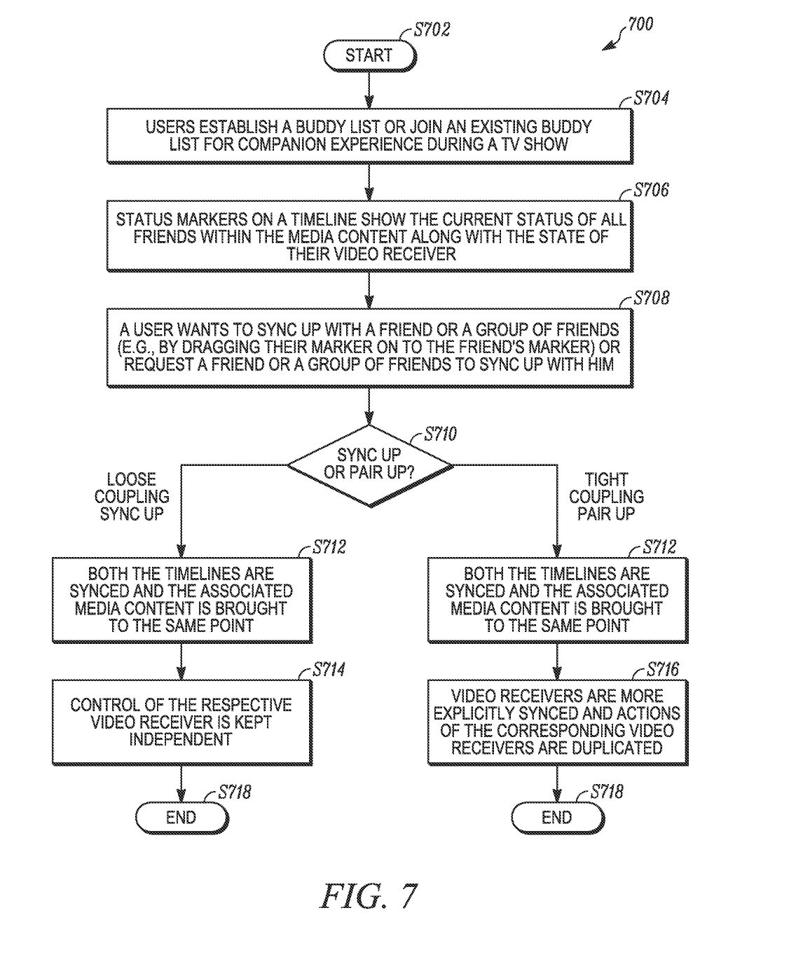

FIG. 7 illustrates a process for a media synchronization system, in accordance with an embodiment of the invention.

As illustrated in the figure, a process 700 starts when a group of users want to have a synchronized media experience through a companion device, while watching the same media content (S702).

Users may establish a buddy list or join an existing buddy list for companion experience during a TV show (S704). For example, buddy list can be established using any known messaging system or method with the companion device. Non-limiting examples of known messaging systems include social networking applications, instant messaging, email, SMS, MMS, chat rooms, blogging websites, etc.

As the users start watching the show from a media player, status icons on a timeline show the current status of all the buddies, who are watching the same show (S706). Note that different users in the buddy list may or may not be at the same position on the timeline. Additionally, the status of different users may or may not be the same, as indicated by the status of their media player. For example, one user may be playing the media content, while another user may have paused the play. In some cases, some of the users from the buddy list may not have even started watching the show.

If a first user from the buddy list, who is watching the show from his media player, wants to synchronize with a second user from the buddy list, the first user may do so by having the media player to drag his icon on to the second user's icon (S708). In another embodiment, one user can have his media player send a request to a media player of a second user. This would enable the first user's media player to synchronize with second user's media player by the second user taking an action on his screen.

A user can decide if he wants to have a tight coupling or loose coupling with a friend, while watching the same TV show (S710). Any known method may be used for deciding. A non-limiting example includes using the user interface, wherein the user may actuate an icon, e.g., double-clicking an icon for tight coupling or double-clicking an icon for loose coupling. Another non-limiting example includes providing a pop-up menu, wherein the user may select a choice in the pop-up menu.

In either case, timelines for both the users are synchronized and the associated media content is brought to the same point so that they are at an identical position within the show (S712).

For the loosely coupled case, when a user synchronizes with a friend or a group of friends, control of their respective video receivers is still kept independent. For example, one user can continue playing the media content, while another user can pause the play independently (S714).

For the tightly coupled case, when a user pairs up with a friend or a group of friends, video receivers are more explicitly synchronized and actions of the corresponding video receivers are duplicated (S716). For example, if one user fast forwards the media content, video receivers for all the paired up users copy the same action by fast forwarding the media content to the same position.

Users can decide to synchronize as desired or play the media content independently for the duration of the TV show. The process ends when the media content is finished playing for all the users or as requested by the users (S718).

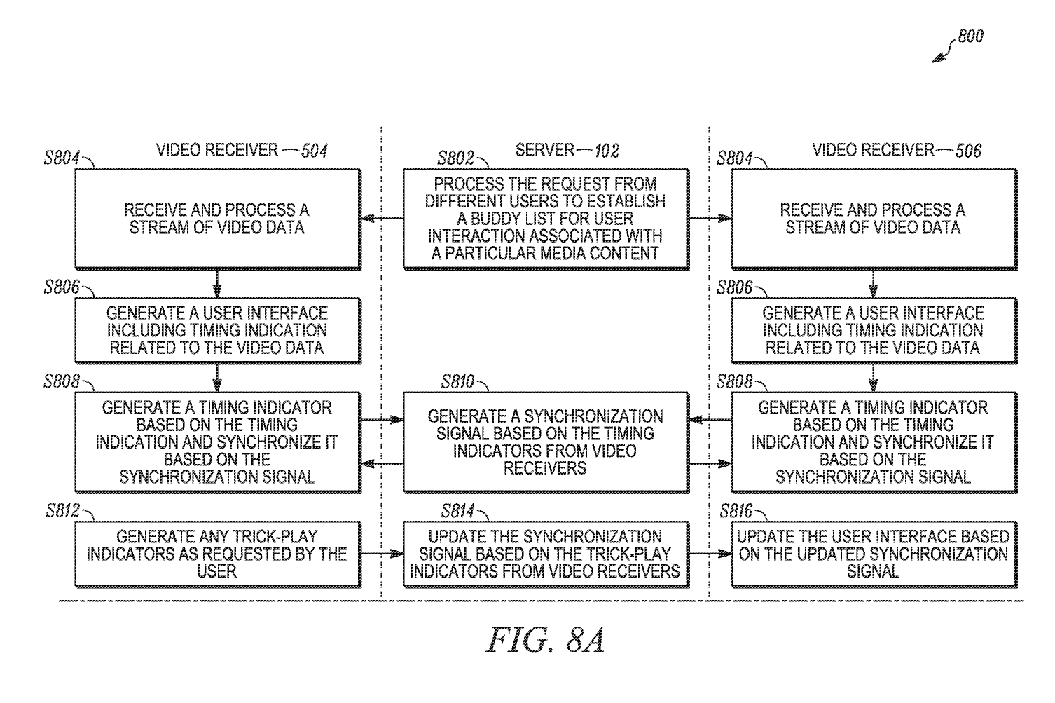

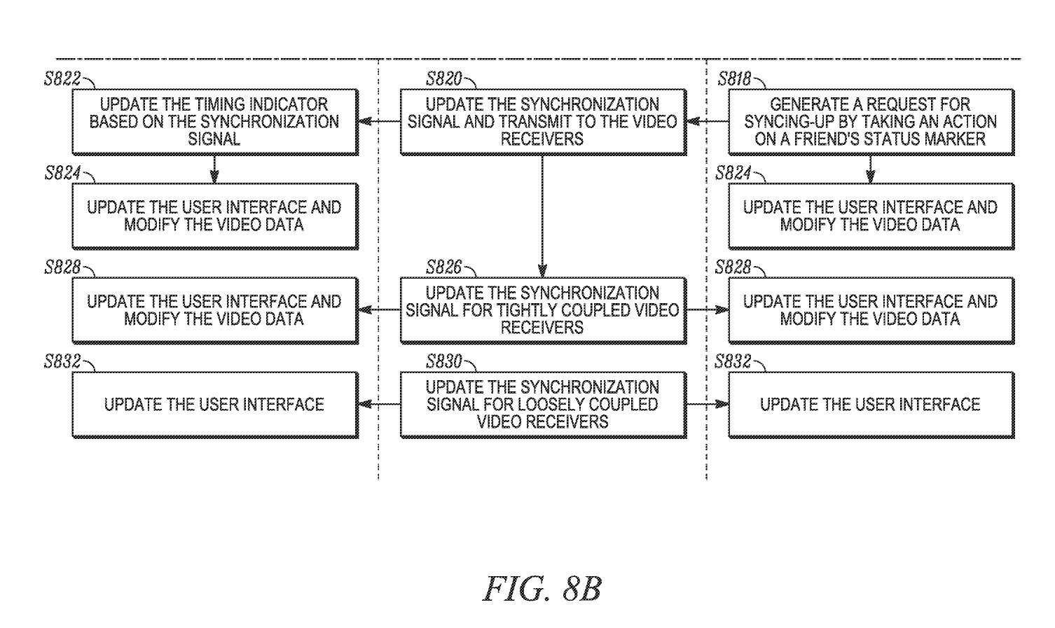

FIGS. 8A-8B illustrates a flow diagram for a media synchronization system, in accordance with an embodiment of the invention.

As illustrated in the figure, a flow diagram 800 includes interaction between server 102, video receiver 504 and video receiver 506 in an example embodiment.

Server 102 processes the request from different users to establish a buddy list for user interaction associated with particular media content (S802).

Video receiver 504 and video receiver 506 receive and process a stream of video data associated with the media content (S804). In one embodiment, the same media content is provided to all the video receivers on a buddy list.

Video receiver 504 and video receiver 506 generate a user interface that includes a timing indication related to the stream of video data (S806). In one embodiment, the timing indication is a timeline on a user's primary screen or companion screen, which indicates the status of the video receiver associated with the video data. In one embodiment, there is a plurality of timelines equal to the number of users in the buddy list who want to watch the same show, where the status of each video receiver is represented by an individual timeline. In some embodiments, each timeline may include personal identification of the user, such as his device, photo, location, etc. In one embodiment, the user interface includes the buddy list showing all the users signed up to watch the same TV show. In some embodiments, different icons with varying color, shape, haptics, sounds, etc., are used to indicate the status of different users. In one embodiment, a spoiler alert flag is generated by the user interface to warn the users.

Video receiver 504 and video receiver 506 generate a timing indicator based on the timing indication and provide it to server 102 for synchronization (S808). Server 102 receives the timing indicators from all the video receivers and generates a synchronization signal based on the timing indicators such that the timeline for all the users, associated with the media content, are synchronized (S810). In one embodiment, the visual interface on primary or companion screen for each user is the same so that their interaction is based on the common information presented to them.

If a user performs a trick play command, such as a fast forward, rewind, pause, etc., on his video receiver, corresponding trick play indicator is forwarded to server 102 (S812).

Server 102 updates the synchronization signal based on the trick play indicators from the video receivers (S814) and provides it to all the video receivers in order for the video receivers to update their user interface to reflect the current status of all the users (S816).

A user can make a request to synchronize with a friend by taking an action on their friend's status icon (a non-limiting example of which includes by dragging their icon on to their friend's icon) through the visual interface (S818).

Server 102 updates the synchronization signal to all the video receivers to reflect the synchronization (S820).

Video receivers update the timing indicator based on the synchronization signal (S822).

Video receivers update the user interface based on the timing indicator and the synchronized video receivers modify the video data to be coupled (S824).

Server 102 updates the synchronization signal for tightly coupled receivers and provides it to the video receivers (S826).

All the video receivers update the user interface and the tightly coupled video receivers modify the video data as well to stay coupled (S828).

Server 102 updates the synchronization signal for loosely coupled receivers and provides it to the video receivers (S830).

All the video receivers update the user interface to reflect the synchronization (S832).

As discussed with reference to FIGS. 7-8, a video receiver sends a timing indicator and media player status (‘non-limiting examples of a status of a media player include pause, play, fast forward, rewind, typing a post, exploring related media, searching content to post, and currently synchronized) to the server in response to a user command, in addition to updating its user interface to reflect the command execution. Server generates a synchronization signal to synchronize all the other video receivers, which in turn update their user interface such that all the users have consistent secondary media experience relating to the primary content they are watching.

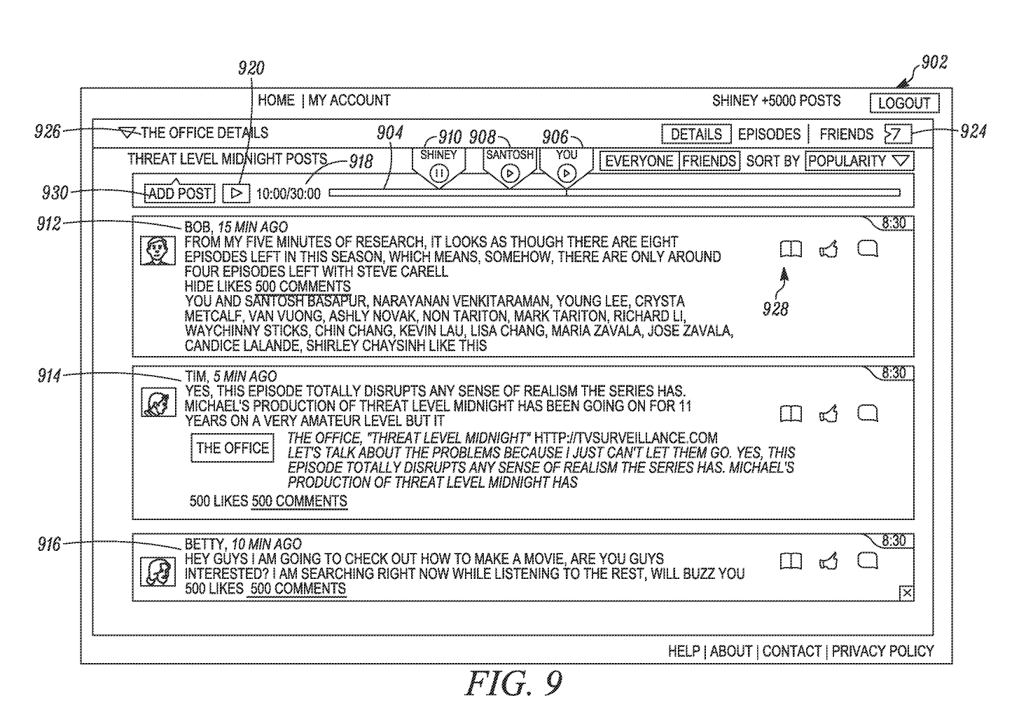

FIG. 9 illustrates an example screen shot for a user interface, in accordance with an embodiment of the invention.

As illustrated in the figure, a user interface 900 includes a screen shot 902. Screen shot 902 illustrates a timeline 904 with status icons for a user 906 (You), a user 908 (Santosh), and a user 910 (Shirley). A timer 918 indicates the elapsed time for user 906 within a TV show 926. In this example, TV show 926 is 30 minutes long and user 906 is 10 minutes in to the show. An icon 920 indicates that user 906 is in “play” status. The status icon for user 908 is at “play” and the status icon for user 910 is at “pause”, and their positions are lagging in time with respect to user 906 within TV show 926. In one embodiment, status icons for user 908 and 910 also indicate elapsed time for all the users on the buddy list watching the same show.

Screen shot 902 also illustrates supplemental content that may by synchronized with the media content. In this example, the supplemental content takes the non-limiting form of a post 912 from user 906, a post 914 from user 908 and a post 916 from user 910. A link 930 provides users an option to post comments. In one embodiment, these posts are associated with a social networking feed as indicated by 928. A clock 922 shows the time when the comments were posted.

In one embodiment, an indicator 924 displays the number of friends who are watching TV show 926. In one embodiment, an indicator displays the buddy list, on which a user can take action, such as to include the buddy list by dragging it on to the timeline or clicking on it. In some non-limiting example embodiments, for tight coupling, server 102 may operate such that the same secondary content may be provided to all users who are tightly coupled. In some non-limiting example embodiments, in loose coupling, different personalized content may be provided to each user, respectively.

Note that screen shot 902 illustrates an example user interface for media synchronization, in accordance with an embodiment of the invention. However, the components of user interface 900 can be arranged in different combinations to indicate user interaction and/or, new indicators can be added to display additional information for the system to provide better services.

In some situations a user may not have access to a television screen but has access to the Internet. In accordance with some non-limiting example embodiments, the user will be able to see the status of his friends on a timeline for the respective media content. In such a timeline, the user will not have his own icon, as he is not consuming media. However, the user will be able to see what his friends are watching with their icons on the timeline indicating the position and status (play, pause etc.).

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A graphic user interface comprising:
a timeline corresponding to a total length of media content to be played by a user on a first media player;
a first icon positioned so as to correspond to a current portion of the media content being played by the first media player; and
a second icon positioned so as to correspond to a current portion of the media content being played by a second media player.

2. The graphic user interface of claim 1,
wherein one of the first icon is operable to be repositioned to the second icon and the second icon is operable to be repositioned to the first icon,
wherein repositioning of the first icon to the second icon enables a current portion of the media content being played by the second media player to be played on the first media player, and
wherein repositioning of the second icon to the first icon enables a current portion of the media content being played by the first media player to be played on the second media player.

3. The graphic user interface of claim 2, wherein performing a fast forward action on the first media player or performing a rewind action on the first media player will reposition the first icon.

4. The graphic user interface of claim 3, further comprising a supplemental content portion operable to display supplemental content that is synchronized with the media content.

5. The graphic user interface of claim 4,
wherein the first icon has a first animation,
wherein the second icon has a second animation, and
wherein the first animation is different than the second animation.

6. The graphic user interface of claim 1, wherein the first icon includes a status indicator indicating that the first media player is currently performing one of the group consisting of playing the media content, a pausing action, a fast forwarding action and a rewinding action.

7. The graphic user interface of claim 1, further comprising a supplemental content portion operable to display supplemental content that is synchronized with the media content.

8. The graphic user interface of claim 1, further comprising:
a second timeline corresponding to a total length of media content to be played by a second user on the second media player,
wherein the first icon is associated with the first timeline, and
wherein the second icon is associated with the second timeline.

9. The graphic user interface of claim 1, wherein the timeline is displayed on a companion device.

10. A method comprising:
displaying, on a graphic user interface, a timeline corresponding to the total length of media content;
displaying, on the graphic user interface, a first icon corresponding to a current portion of the media content being played by a first media player; and
displaying, on the graphic user interface, a second icon corresponding to a current portion of the media content being played by a second media player.

11. The method of claim 10, further comprising:
repositioning one of the first icon to the second icon and the second icon to the first icon,
wherein repositioning of the first icon to the second icon enables a current portion of the media content being played by the second media player to be played on the first media player, and
wherein repositioning of the second icon to the first icon enables a current portion of the media content being played by the first media player to be played on the second media player.

12. The method of claim 11, further comprising:
performing one of a fast forward action on the first media player or a rewind action on the first media player; and
repositioning the first icon based on said performing one of the fast forward action on the first media player or the rewind action on the first media player.

13. The method of claim 12, further comprising displaying, via a supplemental content portion, supplemental content that is synchronized with the media content.

14. The method of claim 13, further comprising providing a supplemental content service with information based on a first user of the first media player and a second user of the second media player.

15. The method of claim 12, wherein said displaying, on a graphic user interface on a first media player operable to play media content, the media content having a total length, a first icon corresponding to a current portion of the media content being played by the first media player comprises displaying the first icon to include a status indicator indicating that the first media player is currently performing one of the group consisting of playing the media content, a pausing action, a fast forwarding action and a rewinding action.

16. The method of claim 10, further comprising displaying, via a supplemental content portion, supplemental content that is synchronized with the media content.

17. The method of claim 16, wherein said displaying, on a graphic user interface on a first media player operable to play media content, the media content having a total length, a first icon corresponding to a current portion of the media content being played by the first media player comprises displaying the first icon to include a status indicator indicating that the first media player is currently performing one of the group consisting of playing the media content, a pausing action, a fast forwarding action and a rewinding action.

18. The method of claim 10, wherein said displaying, on a graphic user interface on a first media player operable to play media content, the media content having a total length, a first icon corresponding to a current portion of the media content being played by the first media player comprises displaying the first icon to include a status indicator indicating that the first media player is currently performing one of the group consisting of playing the media content, a pausing action, a fast forwarding action and a rewinding action.

19. A media player comprising:
a receiving portion operable to receive a stream of video data;
a control portion operable to process the stream of video data;
an output portion operable to output a video of the video data;
a user interface portion operable to generate a user interface that includes a progress bar related to the stream of video data; and
a transmitting portion operable to transmit a synchronization signal to a server;
wherein said receiving portion is further operable to receive a timing indicator from the server, the timing indicator being based on the stream of video data at a second media player,
wherein said control portion is operable to generate an icon, based on the timing indicator, on the progress bar.

20. The device of claim 19, wherein said control portion is further operable to control said output portion to modify the output of the video data based on the synchronization signal.
